(19) United States
(12) Patent Application Publication
(10) Pub. No.: US 2003/0163527 A1
(43) Pub. Date: Aug. 28, 2003

(54) AUDIO-VISUAL MULTIMEDIA NETWORK EXAMINATION SYSTEM AND METHOD

(76) Inventor: Mu-Hsiu Hsu, Taipei Shih (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,812

(22) Filed: Feb. 21, 2003

(30) Foreign Application Priority Data
Feb. 22, 2002 (TW) 91103103

(51) Int. Cl. G06F 15/16

(52) U.S. Cl. 709/204

(57) ABSTRACT

An audio-visual multimedia network examination system and method. The multimedia network examination system includes a user editor, a user browser, a network server and an application server. The user editor edits multimedia examination question data. An examination program is embedded inside the user browser. The examination program calls up the user editor and transmits the multimedia examination question data upstream to the network server. The application server has an analyzer/converter for analyzing the multimedia examination question data and converting the data into an information format file in a cross platform language format. The network server enclosing the application server connects with the user browser through a wide area network. The network server receives the multimedia examination question data submitted from the user browser and returns an electronic examination paper comprising a plurality of information format files in cross platform language.

### CROSS REFERENCE TO RELATED APPLICATIONS

This application claims the priority benefit of Taiwan application serial no.91103103, filed on Feb. 22, 2002.

### BACKGROUND OF INVENTION

1. Field of Invention

The present invention relates to an on-line examination system acting through an audio-visual multimedia network. More particularly, the present invention relates to an examination system capable of reading an examination paper through a computer and providing correct answers in real-time through an audio-visual multimedia network.

2. Description of Related Art

A computer network is really a wide area network that spans the entire globe. The network is connected to various educational institutes, government organizations and various research units around the world through telephone lines or dedicated high-speed links. Anyone familiar with networking techniques can easily exchange information, send out e-mail or transfer documents by hooking up to this network.

At present, the popularity of the World Wide Web (WWW) and multimedia renders remote education possible. A number of research units are currently exploring the possibility of remote education. However, the possibility of remote examination is rarely investigated. Although a few English tests for gauging the standard of students are conducted through the network, the programs are typically written in a close type language such as Microsoft”s visual basic. Consequently, the program cannot be applied to a wide area network.

In addition, a few institutes that conduct on-line examinations of a subject closely related to mathematics often need to attach formulae and graphs on the electronic paper manually leading to awkward textual format and non-aesthetic organization. Furthermore, answers to questions are often provided in a stilted textual form contrary to the interesting teacher-student communication in a classroom setting.

### SUMMARY OF INVENTION

Accordingly, one object of the present invention is to provide a multimedia network examination system and method capable of carrying out examinations on a wide area network. In addition, the electronic paper provided for the examination has an aesthetically appealing appearance and its content is tidy and precise. Answers are provided through video files or data streams so that the entire explanations given by a lecturer is reproduced audio-visually at a client user site, such as the user”s terminal, rather than limited to textual means.

To achieve these and other advantages and in accordance with the purpose of the invention, as embodied and broadly described herein, the invention provides a multimedia network examination system. The system comprises a user editor, a user browser, a network server and an application server. The user editor edits multimedia examination information and the user browser has an embedded examination program for calling the user editor and transferring the multimedia examination information upstream.

The application server further includes an analyzer/converter for analyzing the multimedia examination information and converting the information into a cross platform language format suitable for an information format file. The network server, including the aforementioned application server, is connected to the user browser through a wide area network. The network server receives the multimedia examination information from the user browser and transfers back an examination paper from various information format files to the user browser.

The aforementioned architectural arrangement of the multimedia network examination system is suitable for processing information such as formulae, graphs, texts and data tables only. Provision for processing audio-visual information is absent. To solve this problem, an audio-visual server is provided. The audio-visual server is connected to the network server. The network server is also connected to a user browser through a wide area network for transmitting audio-visual format files and audio-visual examination question data streams to the user browser.

Since the application server inside the network server does not need format conversion of audio-visual information, the included analyzer is only required to determine whether the type of multimedia examination information is audio-visual information.

This invention also provides an audio-visual multimedia network examination method for transmitting audio-visual multimedia examination information upstream from a user terminal. The multimedia network examination method includes using an examination program to call an audio-visual multimedia editor window. A word processing software or an audio-visual processing software drives the audio-visual multimedia editor window. The edited audio-visual multimedia examination information is sequentially transmitted upstream. Thereafter, the user terminal receives an electronic examination paper written in a cross platform language format. The electronic paper actually comprises a plurality of format converted information format files.

This invention also provides an alternative audio-visual multimedia network examination method for processing multimedia examination information at a network server terminal. The multimedia network examination method includes analyzing received multimedia examination information, converting the multimedia examination information into an information format file written in a suitable cross platform language format according to the type and returning an electronic paper using a cross platform language. The electronic paper actually comprises a plurality of format converted information format files.

In brief, this invention utilizes a cross platform language format to carry out on line examination. Hence, the examination can be conducted in a wide area network. In other words, as long as a user has a computer, examinations can be carried out simply through a browser hooked up to a wide bandwidth network. Meanwhile, the word processing software edited multimedia examination information is automatically converted into fixed format information file. Hence, the electronic paper has an aesthetically appealing appearance and an accurate content. In addition, audio-visual information can be transmitted through the audio-visual server. Thus, animated explanations provided by a lecturer may reappear on a display screen at a user”s terminal instead of the conventional stilted textual reply. Moreover, on-line examination is possible in the presence of audio-visual transmission.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow diagram showing on-line question editing in a system having a master-slave architectural design according to this invention;

FIG. 2 is a block diagram showing the flow of a multimedia network examination system according to this invention;

FIG. 3 is a block diagram showing the flow of an audio-visual network examination system according to this invention;

FIG. 4 is a flow diagram showing user”s on-line question editing and examination in a system having a master-slave architectural design according to this invention;

FIG. 5 is a schematic diagram showing the window screen of a user browser according to FIG. 4;

FIG. 6 is a flow diagram showing on-line question editing and examination at a server terminal in a system having a master-slave architectural design according to this invention; and

FIG. 7 is a table that lists out the corresponding information format files after information analysis and conversion.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

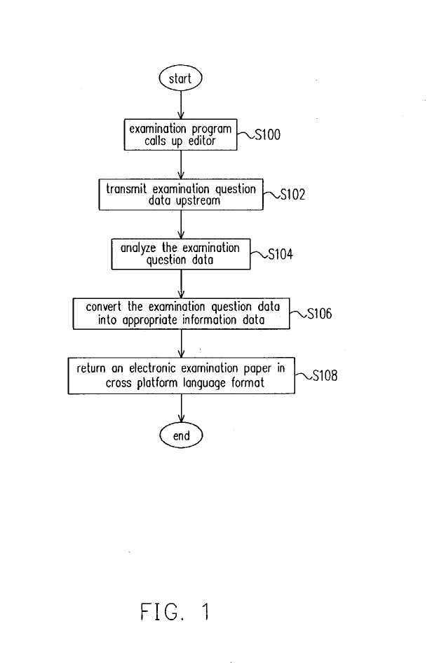

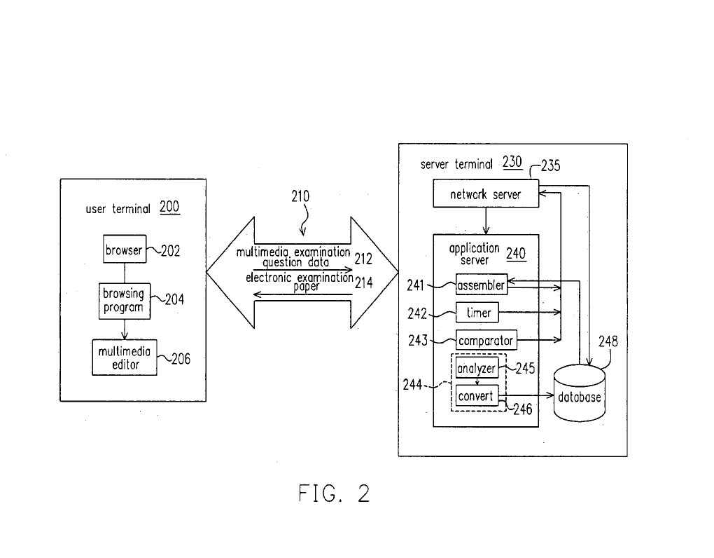

FIGS. 1 and 2 together illustrate a multimedia network examination system and its method of operation according to one embodiment of this invention. In fact, FIG. 1 is a flow diagram showing on-line question editing in a system having a master-slave architectural design according to this invention and FIG. 2 is a block diagram showing the flow of a multimedia network examination system according to this invention.

According to the multimedia network examination system of this invention, the client user site, such as the user terminal, 200 includes a multimedia editor 206 and a browser 202. An examination program 204 is embedded within the browser 202. The server terminal 230 includes a network server 235 and an application server 240. The application server further includes an analyzer/converter comprising an analyzer 244 and a converter 245. In addition, the application server 240 further includes an assembler 241, a timer 242 and a comparator 243.

As shown in FIG. 1, a user such as examiner or tutor wishing to make up questions needs to trigger the browser 202. The browser 202 can be Internet Explorer (IE) or Netscape software. When a network web address of the server terminal 230 is keyed in through the browser 202, a desire to establish a communicative channel between the browser 202 and the server terminal 230 is indicated. After consulting the application server 240 inside the network server 235, the server 235 is ready to take care of the user”s request and set up a transaction channel 210. Thereafter, information and data can be exchanged between them via a wide area network spanning the Internet world.

After a transaction channel 210 is established between the user terminal 200 and the server terminal 230, a suggestive message is issued inquiring the user terminal 200 about the intention to set up an examination program if the server terminal 230 cannot detect any examination program 204 from the user terminal 200. If the user terminal issues a “yes” message, the network server 235 will automatically assist the user terminal 200 to install the examination program 204.

After a proper installation of the examination program 204, the examination program 204 is embedded under the browser 202. If the question setting tutor wants to edit a question database, the examination program 204 will call up the multimedia editor 206 in step s100. The multimedia editor 206 can be a word processing software and the question setting tutor can use the multimedia editor 206 to edit the multimedia examination questions individually. After editing a single multimedia examination question, an upstream forwarding function is set up inside the examination program 204 so that the multimedia examination question data 212 can be transmitted to the network server 235 in step s102. Question editing and question transmission is repeated until the entire question database is edited.

As the multimedia examination question data 212 is transmitted to the network server 235 at the server terminal 230 one by one, the network server 235 will also receive multimedia examination question data 212 from the browser 202 at the user terminal. Thereafter, the network server 235 will immediately transfer the multimedia examination question data 212 to the analyzer/converter 244 inside the application server 240 for further processing. Because the network server 235 only processes data in the cross platform language format such as hypertext markup language (HTML), extensible markup language (XML) and major languages for wide area network communication, the analyzer/converter 244 needs to analyze and convert each multimedia examination question data 212 into an information format file suitable for the particular cross platform language format.

The analyzer 245 inside the analyzer/converter 244 needs to determine the data type of the multimedia examination question data 212 in step s104. According to the data type, the converter 246 converts the data into corresponding information format files such as a graphic interchange file (Gif), a text format file or a table format file in step s106.

The converter 246 transfers the converted information format files into the database 248. When the question setting tutor decides to edit an examination paper, one might draw out a few information files and assemble them into a few electronic paper versions through the assembler 240. Thereafter, the electronic examination papers are transmitted to the network server 235. The network server 235 transmits these electronic papers in a cross platform language format through the transaction channel 210 to the browser 202 of the question setting tutor. The question setting tutor then selects a proper typesetting method so that that version is sent back to the network server 235 for storage inside the database 248.

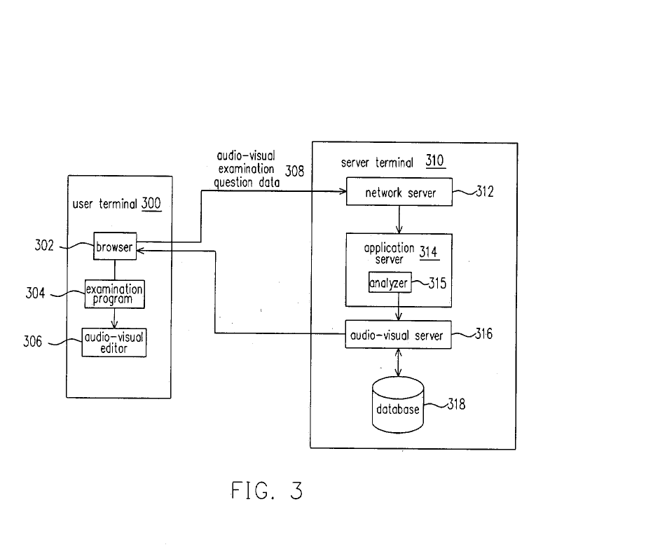

Because the aforementioned system architecture is good only for processing formulae, graphs, text and data table, audio-visual information is disregarded. To solve this problem, this invention provides an audio-visual network examination system. Detailed explanation is illustrated with respect to FIGS. 1 and 3. FIG. 3 is a block diagram showing the flow of an audio-visual network examination system according to this invention.

The audio-visual examination system includes elements having functions that are similar to the ones in FIG. 2. The additional audio-visual server 316 inside the system connects with the user browser 302 through a wide area network. Ultimately, audio-visual information format files and audio-visual examination question data may be directly transferred to the user browser 302 for viewing and listening.

The audio-visual system also uses question setting and question answering operations similar to the system as shown in FIG. 2. The only major difference is that the examination program 304 in step s100 of FIG. 1 for calling the editor is an audio-visual editor 306 (such as Microsoft”s Media Player) instead. Hence, a user may use the audio-visual editor 306 to edit audio-visual examination question data such as audio information for hearing/writing and visual data for speaking. In step s102 of FIG. 1, the examination information transmitted from the browser 302 to the network server 312 is audio-visual examination information 308. When the analyzer 315 within the application server 314 determines that the received examination information is really audio-visual data in step s104, no conversion by the converter 246 is required. Instead, the examination information is transferred to the audiovisual server 316 where the audio-visual examination information is stored inside a database 318.

If a question setting tutor wishes to select an audio-visual examination question from the database 318 and produce an electronic examination paper, audio-visual examination questions are selected from the database 318 through the audio-visual server 316 and directly transferred to the user-end browser 302. Alternatively, if a group of users such as students wishes to take part in an on-line examination and if the analyzer 315 detects a question related to audio-visual information, transactions are directly processed by the audio-visual server 316. Similarly, the audio-visual server 316 will download audio-visual information format files from the database 318 or convert the audio-visual information format files into an audio-visual examination question data stream and transfer such data to the students” browser.

The multimedia system in FIG. 3 and the audio-visual system in FIG. 3 further include a timer 242 and a comparator 243. The timer 242 is used for synchronizing the examination paper distribution and answering period. The comparator 243 is a device for comparing the returned electronic paper with standard answers after the allotted time for answering the examination paper ends. The results of comparison are returned to the browser of each student through the network server 235.

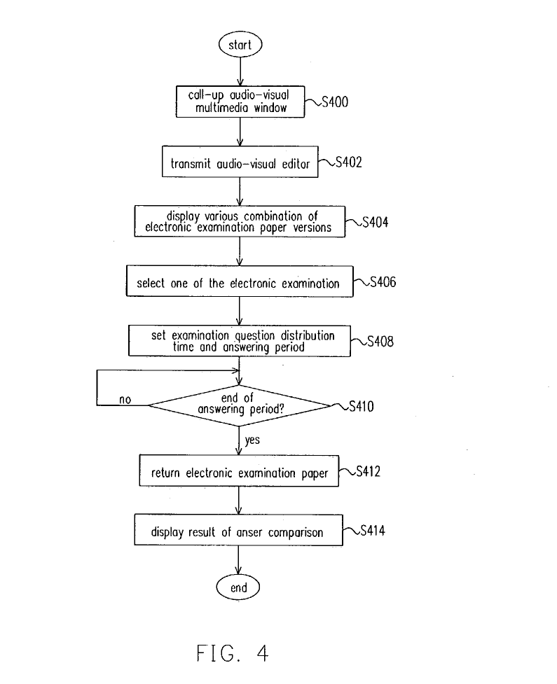

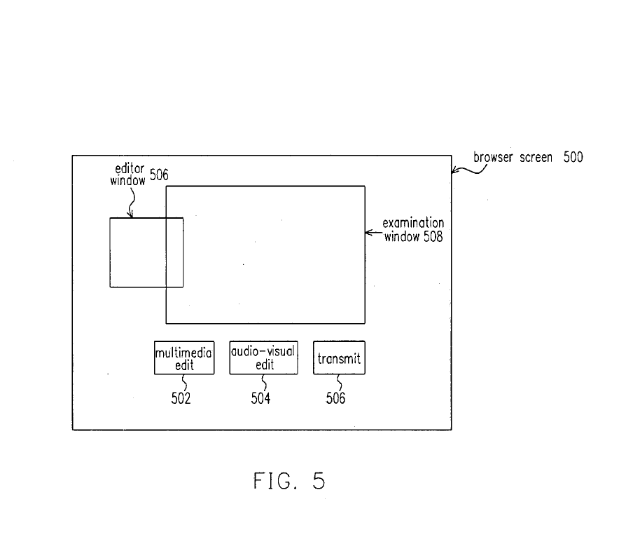

FIG. 4 is a flow diagram showing user”s on-line question editing and examination in a system having a master-slave architectural design according to this invention. FIG. 5 is a schematic diagram showing the window screen of a user browser according to FIG. 4. As shown in FIG. 4, the audio-visual multimedia network examination method includes a number of steps. In step s400, the examination program calls up an audio-visual multimedia editor window. If the question setting tutor desires to edit multimedia examination information, a multimedia editor icon 502 is clicked to show a multimedia editor window 506. The multimedia editor window 506 is supported by word processing software such as Microsoft Word. On the other hand, if the question setting tutor desires to edit audio-visual examination information, the audio-visual editor icon is clicked to show an audio-visual editor window 506. The audio-visual editor window 506 is supported by audio-visual processing software such as Microsoft”s Media Player.

In step s402, the “send” icon is clicked so that the audio-visual multimedia examination question data edited through the audio-visual multimedia editor window 506 is transmitted. In step s404, various combinations of electronic examination papers are displayed on the browser screen 500 as shown in FIG. 5. In step s406, the question setting tutor selects one of the electronic paper arrangements. In step s408, the same question setting tutor chooses the paper distribution time and answering period for that particular examination paper. In other words, on-line examination time and examination duration are set. These settings will be returned to the server as a record.

When a student starts an on-line examination at the examination distribution time, the user terminal may receive an electronic paper from the server written in a cross platform language format. The electronic paper actually comprises an assembly of the aforementioned format converted information format files.

At the end of the answering period, the user terminal transmits the electronic paper back to the server in step s412. The server then carries out a series of statistical calculations to compare answers, assign marks and rank the student. When such calculations are finished, the results are returned to the browser screen of the individual student accordingly.

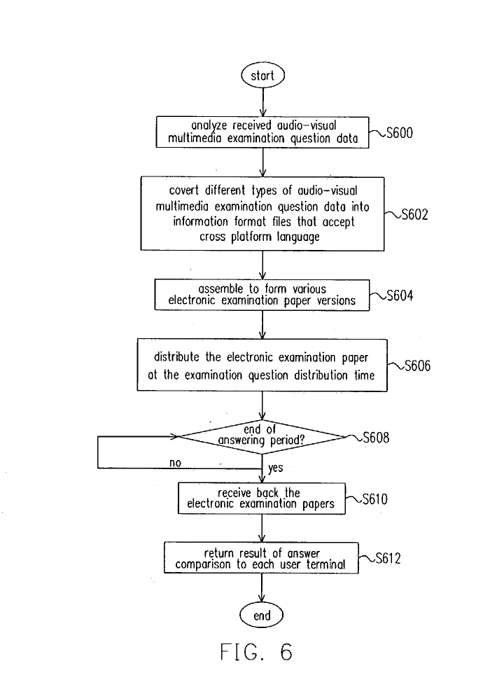

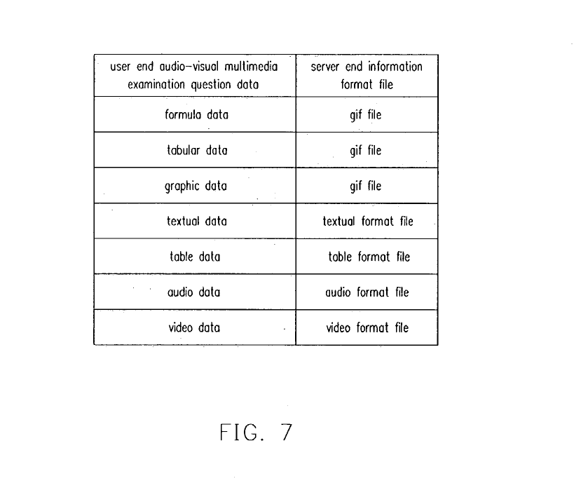

FIG. 6 is a flow diagram showing on-line question editing and examination at a server terminal in a system having a master-slave architectural design according to this invention. FIG. 7 is a table that lists out the corresponding information format files after information analysis and conversion. As shown in FIG. 6, the alternative audio-visual multimedia network examination method includes a number of steps. In step s600, the received audio-visual multimedia examination question data is examined to determine the type of information. In step s602, the data are converted into an information format file suitable to a cross platform language format according to the data type as shown in FIG. 7. When the analyzed audio-visual multimedia examination question data belongs to a data table type, the data are converted to a table file such as *.xls. When the analyzed audio-visual multimedia examination question data belongs to a textual type, the data is converted to a text file such as *.txt. When the analyzed audio-visual multimedia examination question data belongs to an audio-visual type, the data are converted to an audio-visual file such as *.WMA or *.WMV or the data are downloaded to the user terminal as an audio-visual data stream. In addition, when the analyzed audio-visual multimedia examination question data does not belong to any of the above types, the data is converted to a graphic interchange file such as *.gif.

After analysis and conversion of data, the questions are assembled into various electronic paper versions according to the selection of the question setting tutor in step s604. Thereafter, various electronic paper versions are returned in cross platform language format. The question setting tutor then picks up a particular version to serve as the questions in an on-line electronic examination. The tutor also needs to set the distribution time and answering duration of the examination in step s606. As soon as the on-line examination starts at the distribution time, the timer 242 (as shown in FIG. 2) will initiate the counting of the examination period. When the scheduled examination time is finally expired in step s608, the timer 242 informs the network server 235 to retrieve back all the electronic papers in step s610. The comparator 243 (as shown in FIG. 2) then makes a comparison of the answers on each returned examination paper with the actual ones and returns the results to individual user taking the examination.

The aforementioned user client site, such as user terminal, can be, for example, a desktop computer, a personal digital assistant (PDA), a pocket computer, a set-top box or a third generation mobile telephone.

In conclusion, major advantages of this invention includes:

1. Question setting, examination and question answering can be carried out through a wide area network.

2. The electronic paper provided for the examination is aesthetically appealing and its content is accurately arranged.

3. The answer to a question presented by a tutor may appear audio-visually at the user”s terminal.

4. An audio-visual on-line examination is possible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A multimedia network examination system, comprising:
a user editor for editing a plurality of multimedia examination question data individually;
a user browser having an embedded examination program, wherein the examination program serves to call up the user editor and transmit the multimedia examination question data upstream individually;
an application server having an analyzer/converter for analyzing the multimedia examination question data individually and converting the data into information format files in a cross platform language format; and
a network server, including the application server, such that the network server is connected to the user browser through a wide area network for receiving multimedia examination question data transmitted upstream from a user browser and returning an electronic examination paper in cross platform language format to the user browser, wherein the electronic examination paper is an assembly of information data files.

2. The examination system of claim 1, wherein the user editor includes word processing software.

3. The examination system of claim 1, wherein the multimedia examination question data includes formulae, graphs and graphic information.

4. The examination system of claim 3, wherein the analyzer/converter analyzes the multimedia examination question data and converts the data into a graphic interchange format (Gif) file.

5. The examination system of claim 1, wherein the multimedia examination question data includes text data.

6. The examination system of claim 5, wherein the analyzer/converter analyzes the multimedia examination question data and converts the data into a textual format file.

7. The examination system of claim 1, wherein the multimedia examination question data includes data table information.

8. The examination system of claim 7, wherein the analyzer/converter analyzes the multimedia examination question data and converts the data into a table format file.

9. The examination system of claim 1, wherein the cross platform language format is a hypertext markup language (HTML) format.

10. The examination system of claim 1, wherein the cross platform language format is an extensible markup language (XML) format.

11. The examination system of claim 1, wherein the user editor and the user browser may be applied to a desktop computer, a personal digital assistant (PDA), a pocket computer, a set top-box or a third generation cellular phone.

12. The examination system of claim 1, wherein the application server further includes:
an assembler for combining information format files into a plurality of electronic examination paper versions;
a timer for setting a question distribution time and answering period; and
a comparator for comparing the answers in the electronic examination paper with the correct answers and transmitting the results of comparison back to the user browser through the network server.

13. An audio-visual network examination system, comprising:
a user editor for editing an audio-visual examination question data;
a user browser having an embedded examination program, wherein the examination program calls up the user editor and transmits audio-visual examination question data upstream;
an audio-visual server for transmitting an audio-visual information file and an audio-visual examination question data stream to the user browser through a wide area network;
a network server connected to the audio-visual server for transmitting and receiving audio-visual examination question data to and from a user browser through the wide area network; and
an application server inside the network server, wherein the application server includes an analyzer for finding the type of audio-visual multimedia examination question data.

14. The examination system of claim 13, wherein the user editor includes audio-visual software.

15. The examination system of claim 13, wherein the audio-visual examination question data includes audio data and video data.

16. The examination system of claim 15, wherein the analyzer determines if the audio-visual multimedia examination question data is audio and video type of data.

17. The examination system of claim 13, wherein the user browser uses a cross platform language.

18. The examination system of claim 17, wherein the cross platform language is a hypertext markup language.

19. The examination system of claim 17, wherein the cross platform language is an extensible markup language.

20. An audio-visual multimedia network examination method for transmitting a plurality of audio-visual multimedia examination question data from a user terminal, the method comprising the steps of:
using an examination program to call up an audio-visual multimedia editor window;
sequentially transmitting audio-visual multimedia editor window edited audio-visual multimedia examination question data upstream to a server; and
receiving an electronic examination paper in a cross platform language format, wherein the electronic examination paper comprises a plurality of format converted information format files.

21. The examination method of claim 20, wherein the audio-visual multimedia editor window is provided by word processing software and audio-visual processing software.

22. The examination method of claim 20, wherein the cross platform language is a hypertext markup language.

23. The examination method of claim 20, wherein the cross platform language is an extensible markup language.

24. The examination method of claim 20, wherein the user terminal can be a desktop computer, a personal digital assistant (PDA), a pocket computer, a set top-box or a third generation cellular phone.

25. An audio-visual multimedia network examination method for using a network server to process a plurality of audio-visual multimedia examination question data, the method comprising the steps of:
analyzing the received audio-visual multimedia examination question data;
converting the audio-visual multimedia examination question data into a plurality of information format files in a cross platform language format according to the data type; and
returning an electronic examination paper written in the cross platform language format, wherein the electronic examination paper comprises a plurality of information format files.

26. The method of claim 25, wherein the audio-visual multimedia examination question data is converted into a table format file if the received audio-visual multimedia examination question data is found by the analyzer to be tabular data.

27. The method of claim 25, wherein the audio-visual multimedia examination question data is converted into a textual format file if the received audio-visual multimedia examination question data is found by the analyzer to be textual data.

28. The method of claim 25, wherein the audio-visual multimedia examination question data is converted into an audio-visual file or an audio-visual data stream if the received audio-visual multimedia examination question data is found by the analyzer to be audio-visual data.

29. The method of claims 25, 26, 27 and 28, wherein the audio-visual multimedia examination question data is converted into a graphic interchange format (Gif) file if the received audio-visual multimedia examination question data is found by the analyzer to be data other than the tabular data, textual data or audio-visual data.

30. The method of claim 25, wherein the cross platform language format is a hypertext markup language format.

31. The method of claim 25, wherein the cross platform language format is an extensible markup language format.

32. An audio-visual multimedia network examination method for processing a plurality of audio-visual multimedia examination question data between a user terminal and a network server terminal, the method comprising the steps of:
using an examination program to call up an audio-visual multimedia editor window;
sequentially transmitting audio-visual multimedia editor window edited audio-visual multimedia examination question data upstream to a server;
analyzing the received audio-visual multimedia examination question data and converting the data into a plurality of information format files in a cross platform language format according to the type of data; and
returning an electronic examination paper written in cross platform language format, wherein the electronic examination paper is a collection of information format files.

33. The method of claim 32, wherein the method further includes the steps of:
combining the audio-visual multimedia examination question data in various ways to form a plurality of versions;
selecting one of the versions to serve as an electronic examination paper;
setting an examination question distribution time and an answering period;
comparing answers in the electronic examination paper with standard answers at the end of the answering period and returning the results of comparison to the user terminal.
